(19) United States
(12) Patent Application Publication
(10) Pub. No.: US 2026/0174627 A1
(43) Pub. Date: Jun. 25, 2026

(54) APPARATUSES FOR COSMETIC MASSAGE TREATMENT OF THE SKIN

(71) Applicant: Wahidullah RAHIMI, Hamburg (DE)

(72) Inventor: Wahidullah RAHIMI, Hamburg (DE)

(21) Appl. No.: 18/726,535

(22) PCT Filed: Jan. 6, 2023
(86) PCT No.: PCT/EP2023/050212

§ 371 Date: Jul. 3, 2024

(30) Foreign Application Priority Data
Jan. 7, 2022 (DE) 10 2022 100 293.4

(51) Int. Cl. A61H 23/02; A61H 7/00; A61H 15/00; A61H 23/00

(52) U.S. Cl. CPC A61H 23/0263; A61H 7/003; A61H 7/007; A61H 15/00; A61H 15/0092; A61H 23/006; A61H 23/0254; A61H 2201/10

(57) ABSTRACT

A hand-held device provides cosmetic massage treatment of the skin. The massage head bears a compressively resilient massage cushion, on the operating surface of which a plurality of pin-like and/or bristle-like massage elements are uniformly arranged. The hand-held device has a corresponding massage head and an attachment for the massage head for cosmetic massage treatment of the skin.

### REFERENCE TO EARLIER APPLICATIONS

This application claims priority of German patent application No. 10 2022 100 293.4, filed on Jan. 7, 2022, the disclosure of which is hereby incorporated by reference in its entirety.

### FIELD OF THE INVENTION

The present invention relates to devices for active cosmetic massage treatment and blood circulation stimulation of the skin, in particular the facial skin. Such massage devices are used, among other things, in cosmetic methods for the care, tightening and rejuvenation of the skin, in particular the facial skin.

### BACKGROUND OF THE INVENTION

Electric hand-held massage devices generally comprise a body with motorizing means and a massage head comprising massage elements configured to be activated under the action of the motorizing means via a transmission mechanism.

Such massage devices allow massage of larger areas of the body, but are generally not suitable for massaging sensitive areas which comprise a small area and often a small radius of curvature, such as is typically the case with the face.

Special massage devices for various types of facial massage are known from EP 2 862 554 A1, EP 2 862 555 A1 and EP 2 862 556 A1.

The disadvantage of the currently known solutions is that they do not achieve the cosmetic effect and lasting results of more complex methods such as microneedling therapy (also known as “micro-needling” or “percutaneous collagen induction therapy”). In addition, the desired effect often only becomes manifest following a longer massage period.

It is therefore an object of the present invention to provide improved devices for the cosmetic massage treatment of the skin, in particular the facial skin, which at least partially remedy these disadvantages.

This object is solved in accordance with the subject matters of the independent claims. Preferred embodiments are subject matters of the dependent claims, the following description and the FIG.

### DESCRIPTION OF THE INVENTION

A hand-held device for cosmetic massage treatment of the skin, in particular the facial skin, is disclosed.

The hand-held device has a device body, in which an electric drive unit is arranged, and a massage head connected to the device body, which can be set in oscillating or impact movements along its longitudinal axis by the electric drive unit. As the term is used here, oscillating and impact movements also include alternating forward and backward movements that extend only partially along the longitudinal axis and can thus also be included, for example, in vibration movements and the like. Suitable battery-operated and/or mains-powered hand-held devices of this genus are known to the person skilled in the art.

The massage head carries a pressure-elastic configured massage cushion on an end face opposite the device body, i.e. the side that is facing the skin of the person to be treated during use. A plurality of, preferably at least 10 and/or at most 100, pin-shaped and/or bristle-shaped massage elements are arranged substantially uniformly on the working surface of the massage cushion. As the term is used here, “substantially uniform” means that the distances between adjacent massage elements differ from one another by less than 20%, preferably less than 10%, particularly preferably less than 5%. The massage elements extend from the working surface of the massage cushion at least partially along the longitudinal axis of the massage head outwards, i.e. they protrude axially from the working surface in the direction of the skin of the person to be treated. Preferably, at least a part of the massage elements, preferably a predominant part of the massage elements, is oriented substantially normal to the working surface and/or substantially parallel to the longitudinal axis.

The massage treatment of the skin, in particular facial skin, with the hand-held device according to the invention develops pronounced cosmetic effects even within short application times of e.g. 10 to 20 seconds. These effects are measurable and visible, e.g. by means of improved blood circulation, an increase in skin temperature and a firming of the treated skin regions, e.g. by means of a slightly rosy facial color, and are approximately comparable to those of microneedle therapy. In contrast to microneedle therapy, however, the skin is not damaged, meaning that frequent, especially daily or multiple daily treatments are possible. At the same time, topically applied active ingredients such as hyaluronic acid and other active ingredients are absorbed more quickly and more deeply into the skin during or after treatment and can therefore have a better and more lasting effect than with conventional application.

It is essential for the invention that the massage cushion is configured to be pressure-elastic, i.e. it deforms when pressure is applied to the cushion or to the massage elements during contact with the skin and returns to its original shape when the exerted force is removed. In this way, even the particularly thin and sensitive skin of the face can be treated gently and effectively without damaging the skin or the underlying bone or causing pain to the person being treated.

The hand-held device can also comprise different massage heads whose massage cushions differ from one another, for example in their pressure resistance, in order to enable specific adaptation to the respective facial skin to be treated. For example, a massage head for the cheek, chin, neck and décolleté areas may comprise a harder massage cushion and/or a larger working surface than a massage head for the eye area, which usually has the thinnest and most sensitive skin. In contrast, a massage head for the forehead area may comprise a massage cushion of medium size and firmness. In this regard, reference is also made to the following description.

The pressure elastic design of the massage cushion is not particularly limited. In a preferred embodiment, the massage cushion comprises a flexible carrier plate formed at least partially from a flexible material, for example rubber or an elastomer, which is attached to the massage head. For this purpose, the massage head may comprise, for example, a retaining section, in particular configured like a housing, which is enclosed by a partially or completely surrounding retaining edge. The carrier plate is inserted into the retaining section and engages at least partially under the retaining edge of the retaining section like a flange, whereby it is attached to the massage head. Alternatively, the carrier plate can also be molded, tacked or glued to the massage head, for example.

In preferred embodiments, the massage cushion comprises an air-filled chamber arranged between the working surface or the flexible carrier plate and the massage head. Preferably, the chamber extends radially to the longitudinal axis below a substantial part, i.e. more than 50%, of the working surface. In particular, the chamber extends radially to the longitudinal axis below at least 70%, at least 80% or at least 90% of the working surface. The chamber may also comprise a radially circumferentially larger outer diameter than the working surface, so that it extends in a planar manner between all massage elements and the massage head. Preferably, the chamber comprises a height of at least 3 millimeters along the longitudinal axis, preferably at least 5 millimeters. It has been shown that these designs lead to a particularly effective pressure elasticity of the massage cushion.

Preferably, the massage cushion, in particular the carrier plate or the working surface, comprises at least one through-hole through which the air can escape from the chamber to the outside when the massage cushion is under pressure or re-enter the chamber when the pressure is relieved. In this way, a very sensitive pneumatic suspension of the massage cushion is achieved, which has proven to be particularly advantageous for massaging the facial skin.

Alternatively, it is possible to form the massage cushion essentially entirely from the flexible material and to attach it to the massage head in the manner described above. Suitable flexible materials are, for example, foams and natural or synthetic elastomers such as soft rubber, for example in the form of a latex cushion, silicone elastomers or the like.

In another embodiment, the massage cushion comprises a cap formed at least partially from an elastic material, e.g. rubber or silicone, which is mounted on the massage head and embraces it at least partially in a form-locking and/or force-locking manner. The cap comprises a pressure-elastic cushioning layer on the end face of the massage head, which extends radially to the longitudinal axis between the massage head and the massage elements. Alternatively or additionally, a, in particular separate, pressure-elastic cushioning element can be arranged between the cap and the massage head, which forms or comprises the cushioning layer. The cushioning layer or the cushioning element can be an air cushion, foam cushion, silicone cushion or gel cushion, for example.

The pin- or bristle-shaped massage elements can be made of plastic, metal or a natural material such as wood or natural bristles, for example. A combination of these materials and/or a combination of massage elements made of different materials is also possible. Preferably, the massage elements are formed at least partially or completely from an elastomer such as a vulcanizate of natural or synthetic rubber, silicone or other thermoplastic elastomers or a thermoplastic material such as nylon.

The massage elements may comprise a length of at least 5 millimeters and/or at most 25 millimeters, in particular from about 10 millimeters to about 20 millimeters or up to about 15 millimeters. A suitable length is, for example, about 13 or about 15 millimeters.

In preferred embodiments, the massage elements have a rod-shaped shaft part and a spherical or plate-shaped head part at their exposed end, i.e. the end facing away from the working surface, which comprises a larger diameter perpendicular to the longitudinal axis than the rod-shaped shaft part. In this way, superficial injury to the sensitive facial skin by the massage elements and a sensation of pain on the part of the person being treated during the massage are effectively prevented. For example, the rod-shaped shaft part may comprise a diameter of at least about 0.5 millimeters and/or at most about 2 millimeters and/or at most about 1.5 millimeters, in particular at least about 0.8 millimeters and/or at most about 1.2 millimeters. A suitable diameter of the shaft part is, for example, about 1 millimeter. The diameter of the spherical or plate-shaped head part can accordingly be at least about 1 millimeter and/or at most about 3 millimeters, in particular at least about 1.5 millimeters and/or at most about 2.5 millimeters. A suitable diameter of the head part is, for example, about 2 millimeters.

Preferably, the head part is molded onto the shaft part, i.e. the head part and shaft part are formed in one piece from, for example, a rubber-like elastomer, such as a vulcanizate of natural or synthetic rubber or silicone, or from a thermoplastic material, such as nylon. However, it is of course also possible to subsequently attach the head part to the shaft part, for example a plastic head part to a shaft part made of metal or a natural material. The shaft part may additionally comprise an enlarged foot at the end opposite the head part, which is attached to the massage cushion, in particular anchored in it.

It is of course also possible to form the massage elements only with the rod-shaped shaft part and without the head part. Such embodiments are provided in particular for shaft parts with a diameter of at least about 1 millimeter and/or at most about 5 millimeters, in particular of at least about 1 millimeter and/or at most about 4 millimeters or of at least about 2 millimeters and/or at most about 4 millimeters. Preferably, the shaft part in such embodiments consists of a rubber-like elastomer, in particular a vulcanizate of natural or synthetic rubber or silicone. The shaft part can be configured to be conical or tapered from the working surface to the exposed end.

In preferred embodiments, adjacent massage elements are arranged at a distance of at least about 3 millimeters and/or at most about 10 millimeters from each other. A distance of at least about 5 millimeters and/or at most about 8 millimeters is particularly preferred. It has been observed that these distances enable a particularly effective cosmetic massage effect with simultaneous sensitive suspension of the massage cushion.

The connection between the massage head and the device body is not particularly limited. Preferably, the massage head is detachably connected to the device body. In this way, massage heads can be easily exchanged, e.g. to adapt the massage head to the special requirements of different facial areas.

Preferably, the massage head and device body are connected to each other via a push-fit coupling.

In preferred embodiments, the electric drive unit is configured to perform between 800 and 3200 oscillating or impact movements per minute. These frequencies have proven to be particularly effective for cosmetic facial massage. Particularly preferred are approximately 800 to approximately 2500 oscillating or impact movements per minute. Preferably, the electric drive unit is configured to perform the oscillating or impact movements along the longitudinal axis with an amplitude of at least 3 millimeters and at most 12 millimeters, with about 5 millimeters to about 10 millimeters having proven to be particularly advantageous.

In certain embodiments, the hand-held device or the electric drive unit can be configured to set the massage head to oscillating or vibrating movements that extend at least partially transversely to the longitudinal axis of the massage head, in addition to or as an alternative to the oscillating or impact movements along the longitudinal axis. In this way, particularly sensitive areas of the face can be treated gently and effectively. Preferably, the hand-held device or the electric drive unit is configured to set the massage head in oscillating or impact movements along the longitudinal axis as well as in oscillating or vibrating movements transverse to the longitudinal axis, whereby a particularly efficient massage effect is regularly achieved. The amplitude of the oscillating or vibrating movements transverse to the longitudinal axis is preferably at least 1 millimeter and at most 10 millimeters, with approximately 2 millimeters to approximately 5 millimeters proving to be particularly advantageous.

In preferred embodiments, a shock-absorbing element is arranged between the massage head and the device body or the electric drive unit. The shock-absorbing element cushions the impact movements of the massage head and in this way allows particularly gentle treatment of the sensitive facial skin.

The shock-absorbing element is preferably configured in a ring shape, e.g. as a rubber ring, so that it can be slipped onto a coupling socket of the massage head. Of course, it is also possible to attach two or more shock-absorbing elements or rubber rings to the coupling socket in order to adjust the shock absorption according to requirements. The axial thickness of the shock-absorbing element is preferably at least 3 millimeters and/or at most 8 millimeters. A suitable axial thickness is around 4 millimeters.

A further embodiment of the invention relates to a massage head for cosmetic massage treatment of the skin.

According to the invention, the massage head comprises a coupling socket for coupling to an electric massage hand-held device, which is configured to set the coupled massage head into oscillating or impact movements along its longitudinal axis.

The massage head according to the invention carries a pressure-elastic configured massage cushion on an end face opposite the coupling socket, on whose working surface facing away from the massage head a plurality of pin-shaped or bristle-shaped massage elements are arranged essentially uniformly and, starting from the working surface, extend at least partially along the longitudinal axis, i.e. in the axial direction, of the massage head according to the invention.

In preferred embodiments, the coupling socket comprises a push-fit coupling element that is configured to form a form-locking and/or force-locking plug-in connection with a, in particular form corresponding, push-fit coupling receptacle of the massage hand-held device.

A further embodiment of the invention relates to an attachment member for a massage head of a hand-held massage device for cosmetic massage treatment of the skin. The attachment member according to the invention is configured as a cap which can be mounted on the massage head.

The cap comprises a cap wall which surrounds a cap opening and a cap interior extending from the cap opening along a longitudinal axis of the cap. The interior of the cap is configured to receive at least a portion of the massage head in a force-locking and/or form-locking manner. For example, a latching element such as a latching protrusion or a latching groove can be arranged or formed on an inner side of the cap wall, which is configured to engage with a form-corresponding latching element or to receive a form-corresponding latching element of the massage head. It is also possible that the cap wall comprises an annular lip arranged coaxially around the cap opening, which is configured to engage in a latching groove of the massage head or to at least partially engage underneath an underside of the massage head facing away from the end face. The cap or the interior of the cap can, for example, be configured to be essentially cylindrical.

The cap also comprises a cap cover, which closes off the cap interior along the longitudinal axis at an end opposite the cap opening. Preferably, the cap cover is molded onto the cap wall, i.e. the cap cover and cap wall are formed in one piece. On an outer side opposite the chamber interior, the cap cover comprises a working surface with a plurality of pin-shaped or bristle-shaped massage elements which are arranged substantially uniformly on the working surface and extend axially in an outward direction from the working surface at least partially along the longitudinal axis of the cap.

The cap wall and/or the cap lid can comprise a through-hole that extends to the chamber interior and allows air to discharge from the chamber interior to the outside.

Preferably, the cap wall extends along the longitudinal axis, i.e. axially, over at least 10 millimeters, preferably over at least 15 millimeters, particularly preferably over at least 20 millimeters. In this way, a secure fit of the cap on the massage head is ensured, especially without additional holding means.

In preferred embodiments, the cap wall and/or the cap cover is formed at least partially or completely from a natural or synthetic elastomer, e.g. rubber or silicone.

The attachment member also comprises a pressure-elastic cushioning layer which is arranged such that, when the cap is in the attached state, it extends between the massage head and the massage elements radially to the longitudinal axis below a substantial part, i.e. more than 50%, of the working surface. The cushioning layer can, for example, be arranged in the cap cover. In particular, the cap cover or a part thereof may be configured as the cushioning layer. Alternatively or additionally, the cushioning layer can be formed by a pressure-elastic cushioning element which is arranged on an inner side of the cap cover facing the interior of the cap and/or is attached or molded to the cap cover.

The cushioning layer or the cushioning element can be configured analogously to the massage cushion described above. For example, the cushioning layer or the cushioning element can comprise an air-filled chamber, which preferably comprises an access opening through which the air can escape from the chamber to the outside when the cushioning layer or the cushioning element is under pressure or can flow back into the chamber from the outside when the pressure is relieved. Alternatively, it is possible to form the cushioning layer or the cushioning element essentially entirely from a flexible material. Suitable flexible materials include foams and natural or synthetic elastomers such as soft rubber or silicone elastomers. Another possibility is to form the cushioning layer or the cushioning element in the form of a silicone cushion, foam cushion or gel cushion, which is arranged between the cap cover and the massage head, for example, and in this way uses the massage head as an abutment for shock absorption.

Preferably, the cushioning layer or the cushioning element comprises a height or thickness of at least 3 millimeters in the axial direction, preferably at least 5 millimeters, particularly preferably at least 10 millimeters.

Another embodiment of the invention provides a kit of parts for a hand-held massage device, wherein the kit of parts comprises two or more different massage heads or two or more different attachment members according to the above descriptions. In particular, the massage heads or the attachment members may comprise a different shape, a different size, a different number of massage elements and/or a different hardness of the massage cushion or the cushioning layer.

A first massage head or a first attachment member can have an oval working surface, the diameter of which can be, for example, at least about 40 millimeters to at most about 80 millimeters. For example, about 50 to 100, preferably about 60 to 80, particularly preferably about 70 massage elements can be uniformly distributed on the working surface. In this form, the massage head or attachment member is particularly suitable for treating the cheeks, chin, neck and decollete.

A second massage head or a second attachment member can have a round working surface, the diameter of which can be, for example, about 30 millimeters to about 50 millimeters, in particular about 35 millimeters to about 40 millimeters. For example, 20 to 60, preferably 30 to 50 massage elements can be evenly distributed on the working surface. For example, about 35 massage elements can be uniformly distributed on a working surface with a diameter of about 40 millimeters. In this form, the massage head or attachment member is particularly suitable for treating the forehead, temples and scalp.

A third massage head or a third attachment member may have a round working surface, the diameter of which is, for example, about 15 millimeters to about 25 millimeters, in particular about 20 millimeters. For example, 10 to 25 massage elements can be evenly distributed on the working surface, with about 20 massage elements being preferred for a diameter of about 20 millimeters. This allows the massage head or attachment member to be applied completely and evenly to the skin surface and guided over it, also in unevenly shaped facial regions with small radii of curvature. In this form, the massage head or attachment member is therefore particularly suitable for treating the eye area.

In preferred embodiments, the massage cushion of the first massage head or the cushioning layer of the first attachment member is configured to be harder than the massage cushion of the second massage head or the cushioning layer of the second attachment member. The massage cushion of the second massage head or the cushioning layer of the second attachment member is preferably configured to be harder than the massage cushion of the third massage head or the cushioning layer of the third attachment member.

Finally, the invention relates to the use of a massage head described above or an attachment member described above on a hand-held massage device for cosmetic facial treatment.

Moreover, it will be understood that the preferred and advantageous embodiments of the hand-held device for cosmetic massage treatment of the skin according to the invention may also relate, as far as applicable, to the other subject matters of the present invention. Features disclosed above or hereinafter in connection with the hand-held device according to the invention may therefore also relate to the massage head, the attachment member for a massage head, the use thereof and the kit of parts, and vice versa.

In case of doubt, the use of the term “respectively” stands for an “and/or”relationship.

### BRIEF DESCRIPTION OF THE FIGURES

The invention is explained below by means of preferred embodiments with reference to the attached figures. These are merely schematic representations of the principle, not to scale, and are to be understood as examples only. The invention is in no way intended to be limited to the figures shown. For reasons of clarity, recurring features are sometimes not provided with a reference sign more than once. The figures show:

FIG. 1 a perspective view of a hand-held device according to the invention;

FIG. 2 a perspective view (A) and a sectional view (B) of a massage head according to the invention;

FIG. 3 a sectional view of another massage head according to the invention;

FIG. 4 a perspective view (A) and a sectional view (B) of an attachment member according to the invention;

FIG. 5 a sectional view of a massage head with a further attachment member according to the invention.

### DETAILED DESCRIPTION OF EMBODIMENTS

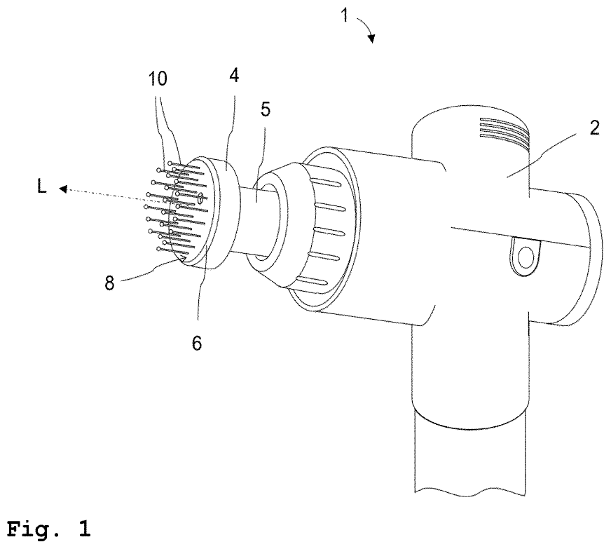

FIG. 1 shows a hand-held device 1 according to the invention for cosmetic massage treatment of the skin with a device body 2 in which an electric drive unit, not shown here, is encased. A massage head 4 is operatively connected to the device body 2 by means of a plug-in coupling 5, so that it can be set in oscillating or impact movements along its longitudinal axis L by the electric drive unit during operation of the device 1.

On its end face opposite the device body 2, the massage head 4 carries a pressure-elastic massage cushion 6, on the working surface 8 of which a plurality of pin-shaped massage elements 10 are arranged uniformly, i.e. at substantially the same distances from one another, and extend outwards from the working surface 8 parallel to the longitudinal axis L of the massage head 4, i.e. in the direction of the skin of a user to be treated.

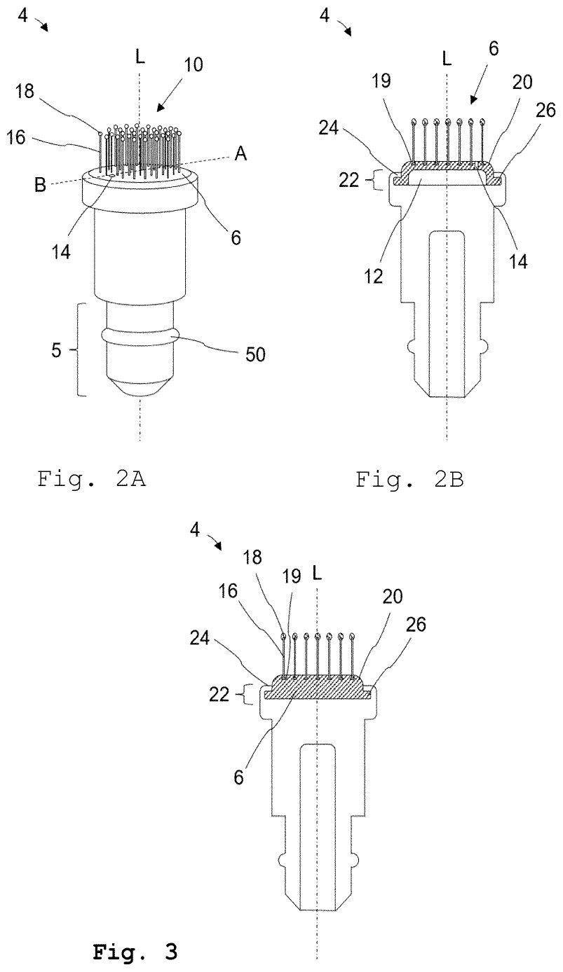

FIG. 2A shows a perspective view of a massage head 4 according to the invention for cosmetic massage treatment of the skin. At one end, the massage head 4 comprises a plug-in coupling socket 5 with an integrally formed annular bead 50, which can be inserted into an annular groove of a complementary plug-in coupling receptacle of a massage hand-held device 1 not shown in FIG. 2, and can be held by the latter in a form-locking and/or force-locking manner. At the other end, i.e. on the end face opposite the plug-in coupling socket 5, the massage head 4 carries a pressure-elastic massage cushion 6, on the working surface 8 of which a plurality of pin-shaped massage elements 10 are uniformly arranged, which extend axially outwards along the longitudinal axis L of the massage head 4 normal to the working surface 8. The massage elements 10 have a rod-shaped shaft part 16, at the exposed end of which there is in each case a spherical head part 18 with an enlarged diameter compared to the shaft part 16.

FIG. 2B shows a sectional view of the massage head shown in FIG. 2A in a sectional view along the sectional line A-B, from which an exemplary structure of the pressure-elastic massage cushion 6 can be seen in more detail. In the example shown, the massage cushion 6 comprises a flexible carrier plate 20 formed from rubber or a rubber-like elastomer, which is inserted into a retaining section 22 of the massage head 4 configured like a housing. The retaining section 22 is surrounded by a retaining edge 24. A flange 26 formed circumferentially on the carrier plate 20 engages under the retaining edge 24 and thereby fastens the carrier plate 20 to the massage head 4.

FIG. 2B further shows that an air-filled chamber 12 is formed between the flexible support plate 20 and the massage head 4, whereby the air can escape out of the chamber 12 via the through opening 14 when pressure is applied to the massage cushion 6, or flow back into the chamber 12 when the pressure is relieved. The sectional view also shows that the massage elements 10 have an enlarged foot 19 at the lower end of the shaft part 16, which is anchored in the support plate 20.

FIG. 3 shows a further variant of a massage head 4 according to the invention. The structure of the massage head essentially corresponds to the example shown in FIG. 2, with the difference that the massage cushion 6 is formed entirely from a foam-like deformable material or a silicone elastomer, which gives the massage cushion 6 the required elasticity under pressure.

FIGS. 4A and 4B show a perspective view (A) and sectional view (B) of an attachment member 30 according to the invention for a massage head 4 of a hand-held massage device 1 for cosmetic massage treatment of the skin. The attachment 30 is designed as a cap 32, which can be mounted on the massage head 4. The cap 32 has a cap wall 34 which surrounds a cap opening 36 and a cap interior 38 extending from the cap opening 36 in the longitudinal direction L of the cap 32. Opposite the cap opening 36, a cap cover 40 closes off the cap interior 38 in the longitudinal direction L. On an outer side opposite the chamber interior 38, the cap cover 40 has a working surface 8 on which a plurality of massage elements 10 are uniformly arranged and extend outwards from the working surface 8 parallel to the longitudinal direction L of the cap 32. In the example shown, the massage elements 10 are designed as one-piece, flexible nylon bristles. The nylon bristles have a shaft part 16, at the free end of which a plate-shaped, round head part 18 is formed and at the respective other end of which an enlarged foot 19 is formed, which is anchored in the cap cover 40. A cushioning layer 42 in the form of a silicone or foam cushion is arranged on the inside of the cap cover 40 facing the chamber interior 38, which extends over a large area between the end face of the massage head 4 and the massage elements 10 and in this way cushions the pressure on the massage elements 10.

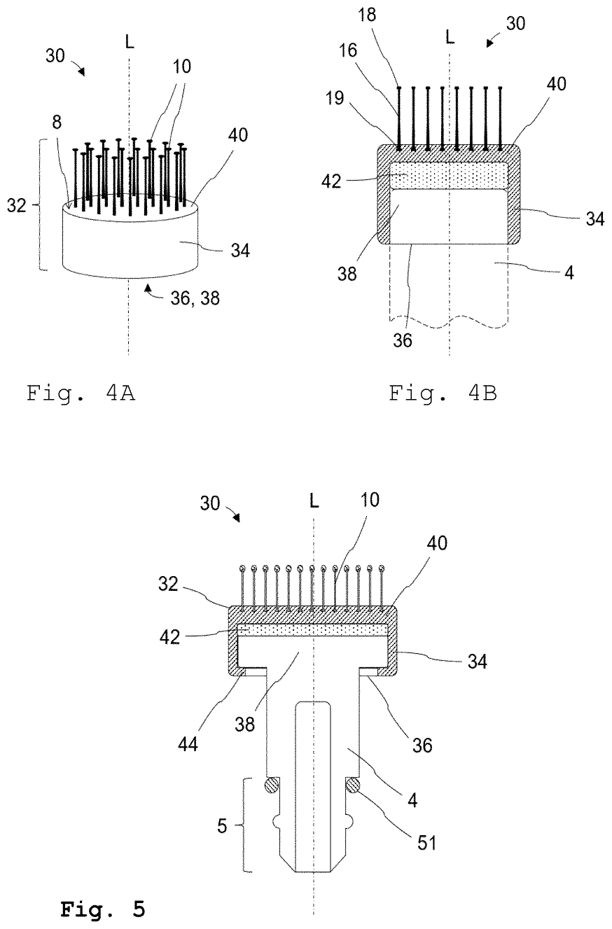

Finally, FIG. 5 shows a sectional view of a further variant of an attachment member 30 according to the invention. The structure of the attachment member 30 basically corresponds to that shown in FIG. 4, although in this example an additional annular lip 44 is formed on the cap wall 34, arranged coaxially around the cap opening 36, which partially engages underneath an underside of the massage head 4 facing away from the end face. Compared to the example in FIG. 4, the cap 32 of the attachment 30 shown in FIG. 5 also has a larger working surface 8 with a larger number of massage elements 10, which are more rigidly cushioned against the massage head 4 due to a thinner cushioning layer 42. In this way, the attachment 30 shown in FIG. 5, for example, is more suitable for large and less sensitive facial areas such as the cheeks or forehead, while the attachment 30 shown in FIG. 4 is advantageous for sensitive, uneven facial areas such as the eye area. The massage head 4 also has a shock-absorbing element 51 in the form of a rubber ring, which is placed on the coupling socket 5 of the massage head 4 and can additionally cushion impact movements during the massage treatment.

The invention is not limited to the description based on the embodiments. Rather, the invention includes any new feature as well as any combination of features, which includes in particular any combination of features in the description and the patent claims, even if this feature or this combination of features is not itself explicitly stated in the patent claims or the description or the embodiments.

### LIST OF REFERENCE SYMBOLS

1 Hand-held device
2 Device body
4 Massage head
5 Coupling socket
6 Massage cushion
8 Working surface
10 Massage elements
12 Chamber
14 Through hole
16 Shaft part
18 Head part
19 Foot
20 Support plate
22 Retaining section
24 Retaining edge
26 Flange
30 Attachment member
32 Cap
34 Cap wall
36 Cap opening
38 Cap interior
40 Cap cover
42 Cushioning layer
44 Lip
50 Plug-in coupling element
51 Shock absorbing element
L Longitudinal axis

1-27. (canceled)

28. A hand-held device for cosmetic massage treatment of skin, the hand-held device comprising:
a device body;
an electric drive unit disposed in said device body;
a massage head connected to said device body and is set in oscillating or impact movements along its longitudinal axis by said electric drive unit; and
a pressure-elastic massage cushion being carried on said massage head on an end face opposite said device body, said pressure-elastic massage cushion having a working surface and on said working surface a plurality of pin-shaped and/or bristle-shaped massage elements are disposed generally uniformly, and extend from said working surface in an outward direction at least partially along the longitudinal axis of said massage head.

29. The hand-held device according to claim 28, wherein said pressure-elastic massage cushion has an air-filled chamber disposed between said working surface and said massage head and extends radially to the longitudinal axis below a substantial part of said working surface and/or has a height of at least 3 millimeters along the longitudinal axis.

30. The hand-held device according to claim 29, wherein said pressure-elastic massage cushion has at least one through-hole formed therein and through said at least one through-hole air can escape from said air-filled chamber to an outside when said pressure-elastic massage cushion is under a compressive load.

31. The hand-held device according to claim 28, wherein said pin-shaped and/or bristle-shaped massage elements are disposed at a distance of at least 3 millimeters and at most 10 millimeters from each other.

32. The hand-held device according to claim 28, wherein said pin-shaped and/or bristle-shaped massage elements are disposed at a distance of at least 5 millimeters and at most 8 millimeters from each other.

33. The hand-held device according to claim 28, wherein said pin-shaped and/or bristle-shaped massage elements have a length of at least 5 millimeters and at most 25 millimeters.

34. The hand-held device according to claim 28, wherein said pin-shaped and/or bristle-shaped massage elements have a length of at least 10 millimeters and at most 15 millimeters.

35. The hand-held device according to claim 28, wherein said pin-shaped and/or bristle-shaped massage elements contain a rod-shaped shaft part and, at an exposed end of said rod-shaped shaft part, a spherical and/or plate-shaped head part, said spherical and/or plate-shaped head part has a larger diameter perpendicular to the longitudinal axis than said rod-shaped shaft part.

36. The hand-held device according to claim 35, wherein the diameter of said rod-shaped shaft part is at least 0.5 millimeters and at most 1.5 millimeters.

37. The hand-held device according to claim 35, wherein the diameter of said spherical and/or plate-shaped head part is at least 1 millimeter and at most 3 millimeters.

38. The hand-held device according to claim 35, wherein the diameter of said spherical and/or plate-shaped head part is at least 1.5 millimeters and at most 2.5 millimeters.

39. The hand-held device according to claim 35, wherein said rod-shaped shaft part contains, at an end opposite said spherical and/or plate-shaped head part, an enlarged foot which is attached to said massage cushion and/or anchored in said massage cushion.

40. The hand-held device according to claim 28, wherein said electric drive unit is configured to perform 800 to 2500 said oscillating or impact movements per minute.

41. The hand-held device according to claim 28, wherein said electric drive unit is configured to perform the oscillating or impact movements with an amplitude along the longitudinal axis of at least 3 millimeters and at most 12 millimeters.

42. The hand-held device according to claim 28, wherein said electric drive unit is configured to perform the oscillating or impact movements with an amplitude along the longitudinal axis of at least 5 millimeters and at most 10 millimeters.

43. The hand-held device according to claim 28, further comprising a shock-absorbing element disposed between said massage head and said device body or said electric drive unit, said shock-absorbing element is configured to cushion the impact movements of said massage head.

44. The hand-held device according to claim 43, wherein:
said massage head has a coupling socket; and
said shock-absorbing element is ring-shaped and configured to be fitted onto said coupling socket of said massage head.

45. A massage head for cosmetic massage treatment of skin, the massage head comprising:
a coupling socket for coupling to an electric hand-held massage device, said coupling socket configured to set a coupled massage head into oscillating or impact movements along its longitudinal axis;
a pressure-elastic massage cushion disposed on an end face of the massage head opposite said coupling socket, said pressure-elastic massage cushion having a working surface; and
a plurality of pin-shaped and/or bristle-shaped massage elements disposed generally uniformly on said working surface and extend from said working surface in an outward direction at least partially along the longitudinal axis of the massage head.

46. The massage head according to claim 45, wherein said coupling socket has a push-fit coupling element which is configured to form a form-locking and/or force-locking push-fit connection with a push-fit coupling receptacle of the massage hand-held device.

47. An attachment member for a massage head of a hand-held massage device for cosmetic massage treatment of skin, the attachment member being configured as a cap and being mountable on the massage head, the attachment member comprising:
a cap wall having a cap opening formed therein and said cap opening leading to a cap interior extending from said cap opening along a longitudinal axis of the cap and said cap interior configured to receive at least a portion of the massage head in a force-locking and/or form-locking manner;
a cap cover closing off said cap interior in the longitudinal axis at an end opposite said cap opening and has, on an outer side opposite said cap interior, a working surface with a plurality of pin-shaped or bristle-shaped massage elements which are disposed generally uniformly on said working surface and extend at least partially in an outward direction from said working surface along the longitudinal axis of said cap; and
a pressure-elastic cushioning layer disposed such that, when said cap is in a fitted state, said pressure-elastic cushioning layer extends between said massage head and said pin-shaped or bristle-shaped massage elements radially to the longitudinal axis below a substantial part of said working surface.

48. The attachment member according to claim 47, wherein:
said cap wall and/or said cap cover is formed at least partially from a natural or synthetic elastomer; and/or
said cap cover is molded onto said cap wall.

49. The attachment member according to claim 48, wherein:
said cap is configured in a cylindrical shape; and
said cap wall extends over at least 15 millimeters along the longitudinal axis.

50. The attachment member according to claim 48, wherein said cap wall and/or said cap cover has a through-hole formed therein and extends to said cap interior and allows air to flow out of said cap interior to outside.

51. A kit of parts for a hand-held massage device, the kit of parts comprising:
at least two different massage heads, each of said massage heads containing:
a coupling socket for coupling to the hand-held massage device, said coupling socket configured to set a coupled massage head into oscillating or impact movements along its longitudinal axis;
a pressure-elastic massage cushion disposed on an end face of said message head opposite said coupling socket, said pressure-elastic massage cushion having a working surface; and
a plurality of pin-shaped and/or bristle-shaped massage elements disposed generally uniformly on said working surface and extend from said working surface in an outward direction at least partially along the longitudinal axis of the massage head; and
at least two different attachment members each according to claim 47.

52. The kit of parts according to claim 51, wherein said massage heads or said attachment members having a different shape and/or different size of said working surface, a different number of said pin-shaped or bristle-shaped massage elements and/or a different hardness of said pressure-elastic massage cushion or said a pressure-elastic cushioning layer.

53. The kit of parts according to claim 51, wherein:
said massage heads including a first massage head, a second massage head, and a third massage head;
said attachments members include a first attachment member, a second attachment member and a third attachment member;
said first massage head or said first attachment member have said working surface being an oval working surface with a diameter of at least 40 millimeters and at most 80 millimeters, on which 50 to 100 of said pin-shaped or bristle-shaped massage elements are uniformly disposed;
said second massage head or said second attachment member with said working surface being a round working surface with a diameter of at least 30 millimeters and at most 50 millimeters, on which 20 to 60 of said pin-shaped or bristle-shaped massage elements are uniformly disposed; and
said third massage head or said third attachment member with a said working surface being a round working surface with a diameter of at least 15 millimeters and at most 25 millimeters, on which 10 to 25 of said pin-shaped or bristle-shaped massage elements are uniformly disposed.

54. A method of performing a cosmetic facial treatment, which comprises the steps of:
providing a massage head containing:
a coupling socket for coupling to a hand-held massage device, the coupling socket configured to set a coupled massage head into oscillating or impact movements along its longitudinal axis;
a pressure-elastic massage cushion disposed on an end face of the message head opposite said coupling socket, the pressure-elastic massage cushion having a working surface; and
a plurality of pin-shaped and/or bristle-shaped massage elements disposed generally uniformly on the working surface and extend from the working surface in an outward direction at least partially along the longitudinal axis of the massage head; and/or
providing the attachment member according to claim 47; and
using the massage head or the attachment member for performing the cosmetic facial treatment.
